(19) United States
(12) Patent Application Publication
(10) Pub. No.: US 2013/0159494 A1
(43) Pub. Date: Jun. 20, 2013

(54) METHOD FOR STREAMLINING DYNAMIC BANDWIDTH ALLOCATION IN SERVICE CONTROL APPLIANCES BASED ON HEURISTIC TECHNIQUES

(71) Applicants: SATYANARAYANA DANDA, Bangolore (IN); PADMANABHAN NARAYANAN, Chennai (IN); NITISH KUNDU, Bangalore (IN)

(72) Inventors: SATYANARAYANA DANDA, Bangolore (IN); PADMANABHAN NARAYANAN, Chennai (IN); NITISH KUNDU, Bangalore (IN)

(73) Assignee: CISCO TECHNOLOGY, INC., San Jose, CA (US)

(21) Appl. No.: 13/326,398

(22) Filed: Dec. 15, 2011

(51) Int. Cl. G06F 15/173

(52) U.S. Cl. 709/224

(57) ABSTRACT

Systems and methods for a predictive bandwidth control module comprising means for maintaining a database of currently active subscribers by receiving the subscriber's authentication events and identifying one or more classes of subscribers based upon the authentication information they provide. The current behavior of the subscribers is recorded based on the applications they launch. The current behavior of the subscribers is correlated with a history database having snapshots of subscriber level requirements for the next few seconds, wherein the correlation provides correlated snapshots values based on the history of subscriber behavior over time. The correlated snapshot values are fed to an existing bandwidth controller that operates at various levels to allocate or de-allocate bandwidth to a corresponding class of subscribers based on a predicted future behavior of the subscribers.

### BACKGROUND

To enable sharing of data among computer users, most computer systems in use today are interconnected via a computer network. Computers in an office, for example, may be connected over a local area network (LAN) to gain access to a server computer, which manages common data storage. As used herein, a server refers to a computer that services and manages requests for data and other files from network computers utilizing wired and wireless communication networks. In the case of an Internet server, the computer network is the Internet. The Internet is a global computer network in which literally millions of user computers communicate with server computers over a widely distributed network.

The number of people and devices using the Internet has been growing at a very fast rate, while the services provided over the Internet are increasingly becoming mission critical. Although more and more people and devices have a need to access computer networks, the bandwidth required to support these needs is limited. Network appliances like the CISCO Service Control Engine (SCE) are deployed in Internet service provider environments and perform functions including: subscriber mapping (upon log in by remote authentication dial in user service and/or dynamic host configuration protocol (RADIUS/DHCP) server), monitor and analyze end-user traffic (by classifying individual/related transmission control protocol and/or user datagram protocol (TCP/UDP) flows) and performs bandwidth control at multiple levels.

Bandwidth control by an Internet service provider (ISP) exists on a Global Level and a Subscriber Level. The Global Level is defined by a set of Global controllers will be used to control the total bandwidth use for the entire system. In contrast, bandwidth management at the Subscriber Level is provided by subscriber bandwidth controllers (BWCs), which control the bandwidth used by individual subscribers. Subscribers are further ranked based on their level of priority in the in the system. For example, there may be Gold, Bronze and Silver level subscribers. This ranking may allow Gold level subscribers to have a higher bandwidth priority than Bronze subscribers, while Silver subscribers may have a higher bandwidth priority than Bronze subscribers, and so on.

When the network is at a certain threshold of congestion and a significant number of Silver or Bronze subscribers are already logged in, if a burst of Gold subscribers login at once, the Gold level subscribers are given priority for any and all network bandwidth that becomes available. Therefore, the bandwidth that was previously available to the Silver and Bronze subscribers is throttled back to make room for the Gold subscribers. Typically each subscriber is given access to a minimum amount of bandwidth or committed information rate (CIR). However, the system may assign more bandwidth to a subscriber based on the application they are using or other needs, this peak information rate (PIR) varies, but it is normally well above the subscriber's standard CIR.

If a number of Gold subscribers login within a short amount of time, the silver and bronze subscriber's bandwidth is throttled back from PIR to CIR levels. This throttling back of bandwidth to may abruptly slow or kill applications in use by the Bronze and Silver subscribers. However, not all of the Gold subscribers may need priority access to all of the available bandwidth, just because they logged in. Therefore, the system need not throttle back the PIR to CIR for every silver or bronze subscriber. Instead, if the system can predict the needs of individual subscribers, based on the subscriber history, it can delay assigning a CIR to gold subscribers who do not have any immediate bandwidth needs, and allow silver and bronze subscribers with critical bandwidth needs to continue to operate at PIR levels.

### SUMMARY

Exemplary embodiments disclosed herein provide a predictive bandwidth control module comprising means for maintaining a database of currently active subscribers by receiving the subscriber's authentication events and identifying one or more classes of subscribers based upon the authentication information they provide. The current behavior of the subscribers is recorded based on the applications they launch and/or the order in which the applications are launched. The current behavior of the subscribers is correlated with a history database having snapshots of subscriber level requirements for the next ‘t’ seconds, wherein the correlation provides correlated snapshots values based on the history of subscriber behavior over time. The correlated snapshot values are fed to an existing bandwidth controller that operates at various levels to allocate or de-allocate bandwidth to a corresponding class of subscribers based on a predicted behavior of the subscribers for the next ‘t’ seconds.

Exemplary embodiments further provide a predictive bandwidth control module, further comprising means for providing a parallel thread that periodically calculates a global bandwidth controller requirements for snapshots of the next t, t+10, t+20, and t+N seconds. The predictive bandwidth control module also comprises means for updating the history database when the snapshots of subscriber level requirements do not correlate with actual subscriber behavior. A sanity check thread that compares the global bandwidth controller requirements for the snapshots with current actual usage of the available bandwidth further verifies the predictive aspects of the controller.

When allocating bandwidth, the predictive bandwidth control module provides a faster committed information rate for a class of subscribers known as Gold subscribers. A second and third class of subscribers known as Silver and Bronze subscribers respectively, wherein Silver subscribers are given priority over Bronze subscribers is provided. The bandwidth control module further comprises means for dynamically selecting a committed information rate for the class of subscribers known as Silver and Bronze subscribers. Therefore, the committed information rate for the Silver and Bronze subscribes is not static in relation to the Gold subscribers.

Furthermore, the described features, advantages, and characteristics of the disclosure may be combined in any suitable manner in one or more embodiments. One skilled in the relevant art will recognize that aspects of the present disclosure can be practiced without one or more of the specific features or advantages of a particular embodiment. In other instances, additional features and advantages may be recognized in certain embodiments that may not be present in all embodiments of the disclosure.

Other features and advantages of the exemplary embodiments should be apparent from the following description of the preferred embodiments, which illustrate, by way of example, the principles of the disclosure.

### BRIEF DESCRIPTION OF THE DRAWINGS

FIG. 1 is illustration depicting a service control engine implementation, according to exemplary embodiments;

FIG. 2 is a flow chart illustrating a method of predictive bandwidth control, according to exemplary embodiments;

FIG. 3 is a schematic block diagram of the predictive bandwidth control module, according to exemplary embodiments; and

FIG. 4 is a schematic block diagram of a service control engine, according to exemplary embodiments.

### DETAILED DESCRIPTION OF EXEMPLARY EMBODIMENTS

For purposes of promoting an understanding of the principle of the disclosure, reference will now be made to the exemplary embodiments illustrated in the drawing(s), and specific language will be used to describe the same. It will never-the-less be understood that no limitation of the scope of the disclosure is thereby intended. Any alterations and further modification of the inventive features illustrated herein, and any additional application of the principles of the disclosure as illustrated herein, which would occur to one skilled in the relevant art and having a possession of this disclosure, are to be considered within the scope of the disclosure.

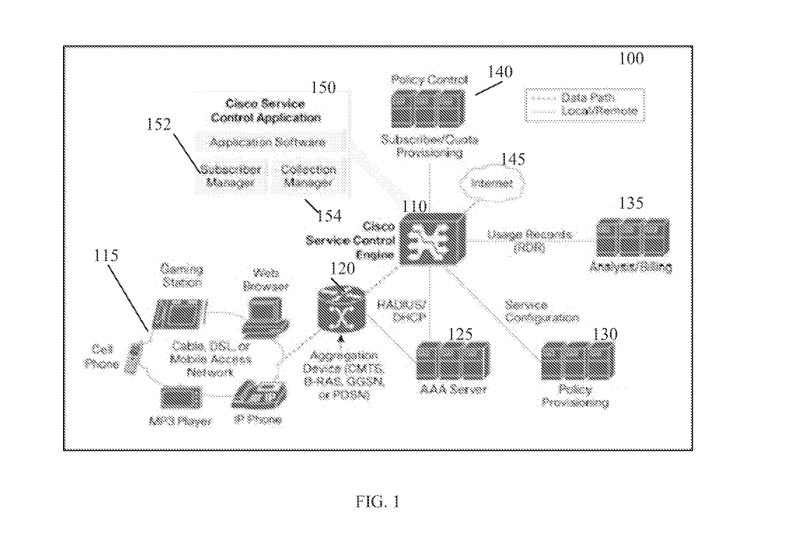

Referring now to the drawings more particularly by reference numbers, a simplified block diagram of an exemplary embodiment of a dynamic bandwidth allocation system is shown in FIG. 1. FIG. 1 illustrates a system 100 for providing a service control engine (SCE) 110 at an Internet service provider (ISP). A SCE is computer network element designed to perform high-capacity stateful application and session-based classification and control of application-level IP traffic per subscriber. Therefore, the SCE 110 controls the subscriber access to the Internet 145 via the ISP, and thus the total bandwidth available to individual subscribers 115 accessing the network 101. A plurality of subscribers 115 connected via an aggregation device 120. An aggregation device 120 is a set of switches that is typically deployed in a central location in order to aggregate data traffic from a plurality of subscribers 115. The aggregation device 120 routes all of this traffic to the SCE 110. The SCE 110 is deployed in an ISP environment and connects to components such as a policy control unit server 140 for subscriber 115 mapping upon log in by a subscriber using remote authentication dial in user service and/or dynamic host configuration protocol (RADIUS/DHCP). The SCE 110 also connects to an Authentication, Authorization and Accounting server (AAA) 125 for authenticating an entity's identity, authorizing a particular entity to perform a given function and accounting for auditing network resource consumption by subscribers 115 and other analytics. A policy control sever 140 is also connected to the SCE 110 for monitoring and analyzing end-user traffic (by classifying individual/related transmission control protocol and/or user datagram protocol (TCP/UDP) flows). An analysis and billing server 135 records usage records for each subscriber for cost allocation and billing. Within the SCE 110 is a Service control application 150 having code for providing a subscriber manager 152 and a collection manger 154. These components allow the SCE 110 to perform bandwidth control at multiple levels.

More specifically, the bandwidth control happens at the Global Level and the Subscriber Level. On the Global level, a set of global controllers will be used to control the total bandwidth used for the entire system. Global controllers provide constraints for large, global volumes of traffic, such as “Total Gold Subscriber Traffic,” or “Total Peer-2-Peer Traffic.” Each global controller defines the maximum percentage of total available bandwidth allocated to all traffic of a particular type. Using a global controller, total traffic of services such as peer-2-peer (P2P) in the system can be limited to any desired percentage of the total available bandwidth. This allows the total bandwidth consumed by subscriber traffic to be kept under control.

Similarly, on a Subscriber Level, subscriber bandwidth controllers (SBWCs) control the bandwidth used by individual subscribers. Each SBWC controls available bandwidth for selected services. Services controlled by a particular BWC are defined per package. Packages are a collection of available services, and may include applications, services, and other data packet requests. Each service can be configured with set of rules and actions.

Each service is also associated with a BWC to maintain Bandwidth per Service. At any instant of time, a subscriber will be assigned to one package and package switch can happen if the policy is configured so. All flows from/to a subscriber are controlled based on the class of the subscriber depending, for example, on the tariff (billing) plan. Therefore it is possible to have a plurality of subscriber classes. For example, tariff based subscriber classes may be provided where bandwidth is allocated based on classes of subscribers 115 including the levels of Bronze, Silver and Gold. In this example, Bronze members have the lowest bandwidth priority, Silver members have a mid-level bandwidth priority and Gold members have the highest bandwidth priority. These subscriber class bandwidth controls are implemented at the Global Level.

In addition to the subscriber classes discussed above, each subscriber 115 has an independent set of bandwidth controls on the Subscriber Level. For example, each subscriber 115 has a single primary (total) bandwidth control (tBWC). The tBWC controls the total bandwidth available to the subscriber 115 and several internal BWCs (iBWCs) that control the available bandwidth of some services (or applications) of that subscriber 115. For example, one BWC may control the streaming of movies to the subscriber 115; another may control downloading of music; while another may control e-mail. Regardless, each individual subscriber is assigned a committed information rate (CIR) that is the minimum bandwidth available to a subscriber based on the subscriber's class (Global Level) and the type of application being accessed (Subscriber Level). The actual bandwidth available to the subscriber 115 may be greater than the CIR in accordance with a peak information rate (PIR). The PIR is the maximum information rate (bandwidth) available to a subscriber 115.

When the bandwidth of the network is at certain threshold of congestion and a significant number of Silver and/or Bronze subscribers are already logged in, the bandwidth available to the Silver and Bronze subscribers will decay rapidly if a burst of Gold subscribers login all around the same period in time. The static rate at which the Gold subscribers will get their CIR at login, and the rate at which the other (Silver/Bronze) subscribers to decay back to their CIR (from PIR) will depend on parameters like “Assurance Level” (AL) which defines the decay rate in such cases.

This will also impact at the global level as well. It should be noted that the bandwidth controller in all these cases determines each subscriber's 115 bandwidth flows near-instantaneous rate based on the flows that have “already been created” and identified as belonging to a particular class and deserving a CIR. Based on the assurance level (AL), Gold subscribers/applications may take a few minutes before they get their CIR. However, if the AL values are biased in favor of Gold subscribers and applications beyond a certain level, the other bronze and silver subscribers will decay at a much more rapid rate, which may abruptly slow and kill the applications accessed by the Silver and Bronze subscribers 115.

Embodiments herein solve the problem of the rapid decay of Silver and Bronze subscriber's PIR to CIR bandwidth rates by providing a method of dynamically determining which subscribers tend to require higher bandwidth based on past behavior. Methods disclosed herein provide a method of predicting what an individual subscriber or group of subscribers will do once they log in by building a history of subscriber activity over a period of time. Therefore, if a number of Gold subscribers log in, but do not need immediate access to a lot of bandwidth or a minimum CIR assignment, the system can allow certain Silver and Bronze subscribers, who have a greater bandwidth need, to finish their tasks in progress before downgrading their PIR to CIR levels. The system can then update the Gold subscribers CIR once the Silver and Bronze subscriber's tasks are completed. In another embodiment, the system downgrades Bronze subscriber's bandwidth from PIR to CIR first, then it downgrades any Silver subscriber's bandwidth to make room for the Gold subscribers.

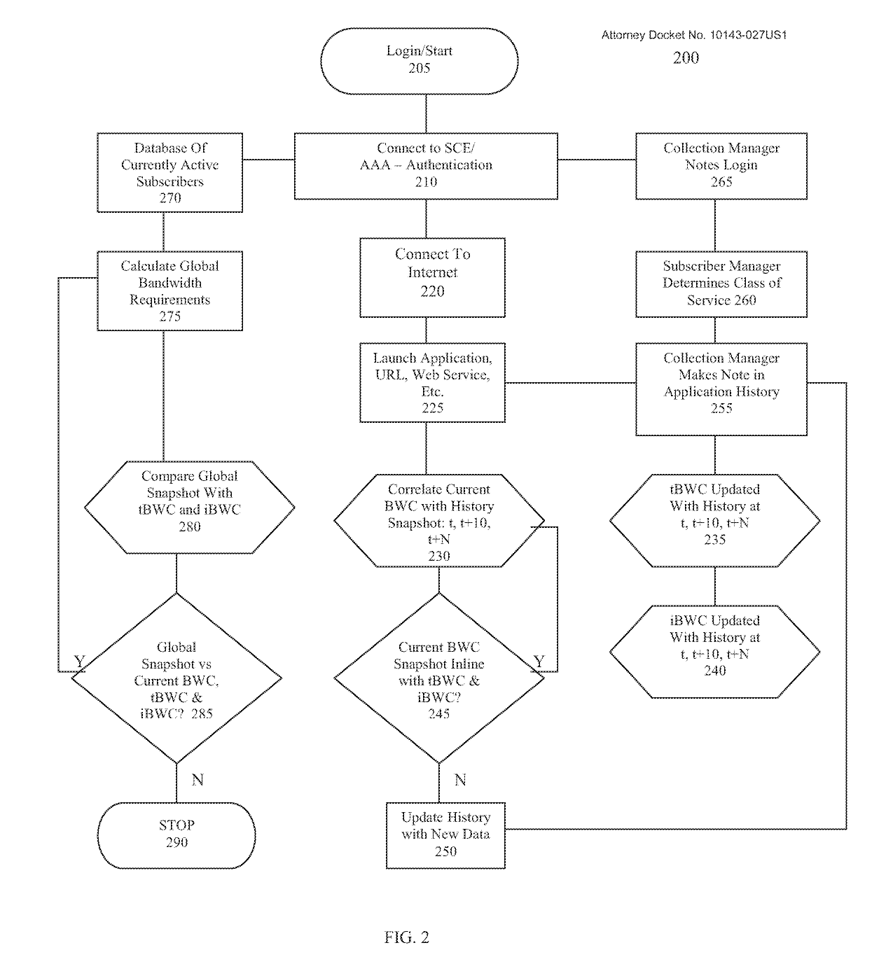

Turning now to the flow chart in FIG. 2, a method 200 is disclosed for providing subscribers with dynamic bandwidth allocation based on their classification (e.g. gold, silver or bronze). This embodiment solves the bandwidth allocation problem by predicting what a certain subscriber is going to do by building the history of the subscriber's activities over a period of time.

In FIG. 2 a subscriber logs into the system at step 205. The SCE 120 and AAA server 125 authenticates the identity of the user, authorizes the subscriber's connection and identifies their class of service in step 210. At step 220, the subscriber is connected to the Internet. At step 265 the Collection Manager records the subscriber's login and updates the database of current active subscribers in step 270. The Subscriber Manager determines the class of service available to the subscriber at step 260. At step 225 the subscriber launches a web application such as a browser window, Internet video streaming service, e-mail application, etc. When these applications are launched, the Collection Manager makes note of a plurality of analytics involving the lunch of these applications in step 255. The collection manager stores these analytics in a subscriber history database in step 255. Some of the recorded analytics may include, for example, the time the applications were launched, the sequence in which the applications were launched, the frequency at which applications are launched by this subscriber at this time and in this sequence, the amount of data accessed by these applications, the average length of time the subscriber uses these applications, etc. Next, the SCE 110 correlates the current bandwidth allocations with the historical allocation of bandwidth based on a subscriber's history of prior use in step 230. Here, the SCE 110 may look a current time “t” plus 5, 10, 15 seconds into the future. This allows the SCE 110 to increase the bandwidth PIR rate for an application (e.g. streaming video) to a subscriber dynamically based on the subscribers pass use of the application.

The SCE 110 also determines if a snapshot of the current bandwidth available to a subscriber or subscriber's application is inline with the subscriber's actual bandwidth use by taking into account the subscribers total bandwidth control (tBWC) and internal bandwidth control (iBWC) in step 245. If they are in line, the system continues its correlation at step 230 to allow dynamic adjustment to the CIR, PIR and AL. However, if it is found that the current BWC is not consistent with the tBWC and iBWC, the system attempts to update the subscriber history with this new data in step 250.

Similarly to the subscriber level of bandwidth allocation discussed above, the method 200, also considers global bandwidth allocations. In step 270, method 200 maintains a database of currently active subscribers 270. These subscribers calculate the global bandwidth requirements of the system in step 275. In steps 280 and 285, a snap shot of the global bandwidth is compared the actual subscribers experience of global bandwidth allocation. If the global level bandwidth is inline with the subscriber level bandwidth allocation, the system continues to dynamically update the bandwidth requirements at step 275. However, if the global level bandwidth is inconsistent with the subscriber level bandwidth, the system may adjust for this by ending the dynamic allocation and switching back the default or static allocation of bandwidth.

The method 200 described in the flow chart provides a method of predicting what a subscriber might do based the subscriber's usage patterns over a period of time. The system 200 determines the bandwidth allocation during the subscriber login delay. It should be noted that in typical cases, the following delays could be significant (i.e. of the order of a few to 10 s of seconds): (a) the time a subscriber gets authenticated until the time she/he launches the first application. In many cases, this delay is sufficient to prepare the system for a number subscribers logging in and their behavior. In other words, this gives the system time to allow the Silver and Bronze subscribers to complete their tasks before downgrading their PIR to CIR, which is a process that frees up more bandwidth to the Gold subscribers. If more delay is needed, in most of the deployments, the Radius traffic will go through the SCE 110 where this can be provided a SCE Radius sniffer, which can analyze the Radius packet. The SCE radius sniffer can ascertain subscriber parameters (e.g. name) from Access-Accept packet, which is provided for all authenticated users. This occurs before SCE 110 receives the LOGIN event or a first flow in case of a subscriber who is anonymous to the SCE box 110. (b) Another delay is the time a subscriber accesses a webpage to the time the subscriber initiates the associated application. Each of these delays will allow the SCE 110 to have additional time to dynamically adjust the allocation of bandwidth among subscribers.

It is possible to maintain a weighed history buffer (DB), which consists of: recording when a subscriber launches an initial application based on time of day. The correlation between launching multiple applications, and say, accessing a particular URL followed by initiating a P2P session (e.g. application Y gets launched, then 10 seconds after URL X is visited). Another example might be, after a subscriber launches application Z, the subscriber usually logs out 10 seconds later. Such a history buffer (Predictor DB) is constructed on a per-subscriber basis and is meant to give a probabilistic model of the subscribers behavior in terms of applications/flow creation/usage. This model could actually be constructed as a number of micro-finite state machines (FSMs) per-subscriber. Therefore, in an exemplary embodiment, the system may allocate CIR bandwidth to each subscriber based on its individual FSM.

Note that an appliance like SCE 110 also has the ability to track application initiations/terminations by subscribers through its usage records (RDR) mechanism 135 shown in FIG. 1. The Predictive BWC (PBWC) module can either be part of such an appliance like the SCE 110 or it can be collocated on a computer network as a software application. The PBWC essentially provides a more realistic rate of CIR/PIR growth or decay and will result in a better subscriber end-user experience irrespective of the service class of the subscribers/applications involved. Thus, it provides a faster CIR for gold subscribers/applications and a graceful policing for bronze subscribers/applications versus using the traditional static parameters for reducing bandwidth among subscribers.

In the SCE 110 solution discussed above, the RDR send data to the Collection Manager 154 device for accounting and reporting. This data can further be used to update the PWBC database periodically based on each subscriber. With in SCE 110 providing a Subscriber database, just a few parameters can be associated, in order to track the subscriber behavior. If there is a significant change in the predictable attribute values, this can be used to update the PWBC database. The PWBC database predictive analysis may also take into consideration, location vs. time, time based on the well-known events, speculations, political interest, etc.

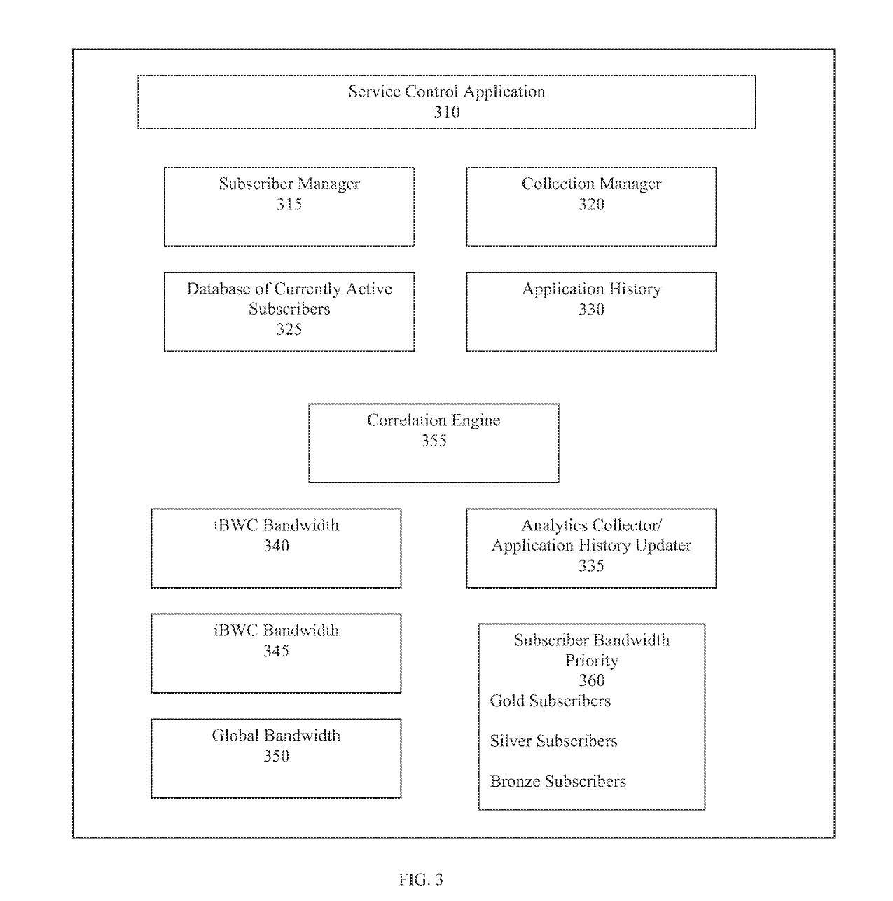

FIG. 3 is a block diagram of a service control application (SCA) 310. The application executes on the SCE 110 described above. In an alternative environment, the SCA 310 may also execute on a virtual SCE 110 on a network server or other computer. The service control application includes a Subscriber Manager 315 for maintaining a database of currently available subscribers 325. The database of currently available subscribers 325 includes all subscribers currently logged in and authenticated by the system. The Subscriber Manager also manages the subscriber classification and bandwidth priority table 360. The Collection Manager 320 manages of the analytics collection mechanisms and the application history updater 335, the Application History database 330 and the Correlation Engine 355. The Collection Manager 320 further maintains the total bandwidth control module 340, the internal bandwidth control module 340 for each subscriber, as well as, the Global bandwidth control module 350. This application is designed to implement the embodiments disclosed in FIG. 2 above.

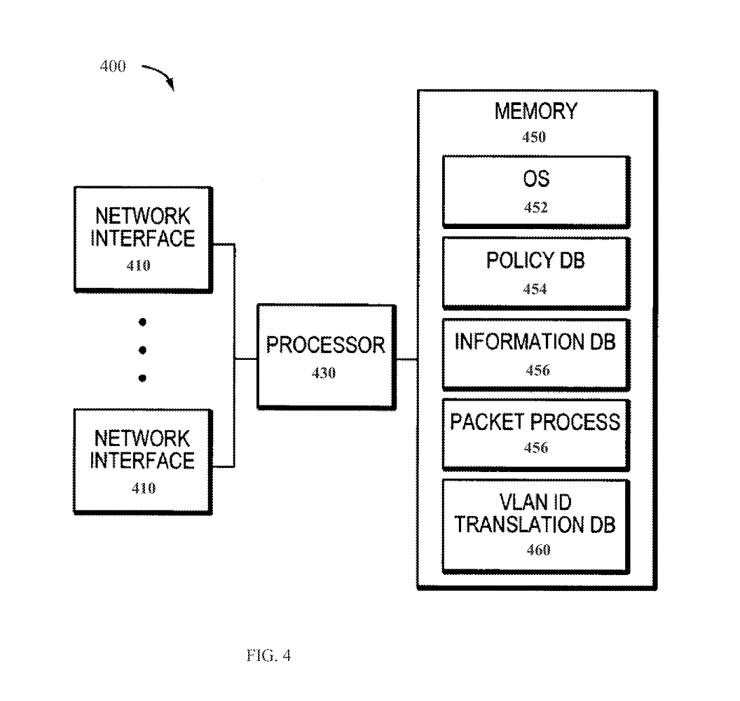

FIG. 4 is a high-level block diagram of an exemplary SCE 400 that may be used with the present disclosure. An example of an SCE that may be used with the present disclosure is the Cisco SCE 2000 available from Cisco Systems Incorporated. SCE 400 comprises one or more network interfaces 410, a processor 430 and a memory 450. The network interfaces 410 connect (interface) the SCE 400 with the network 101 and enable data packets to be transferred between the SCE 400 and the network 101 using various protocols, such as Ethernet. To that end, the network interfaces 410 comprise conventional interface circuitry that incorporates signal, electrical, and mechanical characteristics and interchange circuits needed to interface with the physical media of the network 101 and protocols running over that media.

The processor 430 is a conventional CPU configured to execute instructions and manipulate data contained in the memory 450. The memory 450 is a conventional RAM comprising e.g., DRAM devices. The memory 450 contains an operating system 452, policy DB 454, information DB 456, packet process 458 and a Virtual Local Area Network (VLAN) identifier (ID) translation DB 660.

The operating system 452 is a conventional operating system that comprises computer-executable instructions and data configured to support the execution of processes, such as packet process 458, on processor 430. Specifically, operating system 452 is configured to perform various conventional operating system functions that, e.g., enable the processes to be scheduled for execution on the processor 430 as well as provide controlled access to various resources on the SCE 400, such as memory 450. The policy DB 454 is a database comprising policy information that is applied to packets processed by the SCE 400 and the information DB 456 is a database comprising information about the packets. This information may include statistical information that is maintained by the SCE 400 for the processed packets. Packet process 458 is a software process comprising computer-executable instructions and data structures configured to process packets received by the SCE 400 in accordance with an aspect of the present disclosure.

Thus, while the present disclosure has been fully described above with particularity and detail in connection with what is presently deemed to be the most practical and preferred embodiment of the disclosure, it will be apparent to those of ordinary skill in the art that numerous modifications, including but not limited to, variations in size, materials, shape, form, and function and manner of operation, assembly and use may be made without departing from the principles and concepts of the disclosure as set forth in the claims. Further, it is contemplated that an embodiment may be limited to consist of, or to consist essentially of one or more of the features, functions, structures, methods, described herein.

What is claimed is:

1. A system for predictive bandwidth control module comprising:
a service control engine having means for maintaining a database of currently active subscribers by receiving subscriber's authentication events and identifying one or more classes of subscribers based upon authentication information provided by the subscribers,
means for recording current behavior of the subscribers based on applications they launch,
means for correlating the current behavior of the subscribers with a history database having snapshots of subscriber level requirements for a next t seconds,
wherein the correlation provides correlated snapshots values based on a history of subscriber behavior over time, and
wherein the correlated snapshot values are fed to an existing bandwidth controller that operates at various levels to allocate or de-allocate bandwidth to a corresponding class of subscribers based on a predicted behavior of the subscribers for the next t seconds.

2. The system of claim 1, further comprising means for providing a parallel thread that periodically calculates a global bandwidth controller requirement for snapshots of the next t, t+10, t+20, and t+N seconds.

3. The system of claim 1, further comprising means for updating the history database when the snapshots of subscriber level requirements do not correlate with actual subscriber behavior.

4. The system of claim 2, further comprising means for providing a sanity check thread that compares the global bandwidth controller requirement for snapshots with current actual usage of available bandwidth.

5. The system of claim 1, further comprising means for providing a faster committed information rate for a class of subscribers known as Gold subscribers.

6. The system of claim 1, further comprising means for dynamically selecting a committed information rate for a class of subscribers known as Silver and Bronze subscribers, wherein Silver subscribers are given priority over Bronze subscribers.

7. A method of providing a predictive bandwidth control module comprising:
maintaining a database of currently active subscribers by receiving subscriber's authentication events and identifying one or more classes of subscribers based upon authentication information provided by the subscribers,
recording in a database current behavior of the subscribers based on applications they launch,
correlating the current behavior of the subscribers with a history database having snapshots of subscriber level requirements for a next t seconds, wherein the correlation provides correlated snapshots values based on a history of subscriber behavior over time, and wherein the correlated snapshot values are fed to an existing bandwidth controller that operates at various levels to allocate or de-allocate bandwidth to a corresponding class of subscribers based on a predicted behavior of the subscribers for the next t seconds.

8. The method of claim 7, further comprising providing a parallel thread that periodically calculates a global bandwidth controller requirement for snapshots of the next t, t+10, t+20, and t+N seconds.

9. The method of claim 7, further comprising updating the history database when the snapshots of subscriber level requirements do not correlate with actual subscriber behavior.

10. The method of claim 9, further comprising providing a sanity check thread that compares a global bandwidth controller requirement for snapshots with current actual usage of available bandwidth.

11. The method of claim 7, further comprising providing a faster committed information rate for a class of subscribers known as Gold subscribers.

12. The method of claim 7, further comprising dynamically selecting a committed information rate for a class of subscribers known as Silver and Bronze subscribers, wherein Silver subscribers are given priority over Bronze subscribers.

13. A predictive bandwidth control module comprising:
a service control application executable on a service control engine having code for maintaining a database of currently active subscribers by receiving subscriber's authentication events and identifying one or more classes of subscribers based upon authentication information provided by the subscribers,
a database for recording current behavior of the subscribers based on the applications they launch, and
a correlation engine correlating the current behavior of the subscribers with a history database having snapshots of subscriber level requirements for a next t seconds, wherein the correlation provides correlated snapshots values based on a history of subscriber behavior over time, and wherein the correlated snapshot values are fed to an existing bandwidth controller that operates at various levels to allocate or de-allocate bandwidth to a corresponding class of subscribers based on a predicted behavior of the subscribers for the next t seconds.

14. The predictive bandwidth control module of claim 13, further comprising a parallel thread that periodically calculates a global bandwidth controller requirement for snapshots of the next t, t+10, t+20, and t+N seconds.

15. The predictive bandwidth control module of claim 13, further providing periodic updates to the history database when the snapshots of subscriber level requirements do not correlate with actual subscriber behavior.

16. The predictive bandwidth control module of claim 15, further providing a sanity check thread that compares a global bandwidth controller requirement for snapshots with current actual usage of available bandwidth.

17. The predictive bandwidth control module of claim 13, further providing a faster committed information rate for a class of subscribers known as Gold subscribers.

18. The predictive bandwidth control module of claim 13, including dynamically selecting a committed information rate for a class of subscribers known as Silver and Bronze subscribers, wherein Silver subscribers are given priority over Bronze subscribers.

19. The predictive bandwidth control module of claim 13, wherein the predictive control module is stored and executes on a service control engine appliance.

20. The predictive bandwidth control module of claim 13, wherein the predictive control module executes within a virtual service control engine appliance.
